(19) United States
(12) Patent Application Publication
(10) Pub. No.: US 2009/0090655 A1
(43) Pub. Date: Apr. 9, 2009

(54) Additive Useful for Stabilizing Crude Oil

(75) Inventors: Joseph L. Stark, Richmond, TX (US); Koral B. Johnson, Pasadena, TX (US)

Correspondence Address: MADAN, MOSSMAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 12/246,057

(22) Filed: Oct. 6, 2008

Related U.S. Application Data
(60) Provisional application No. 60/977,426, filed on Oct. 4, 2007.

(51) Int. Cl. C10G 29/20; C08G 8/10; C08L 61/06

(52) U.S. Cl. 208/290; 525/397; 524/611

(57) ABSTRACT

Crude oils, especially heavy crude oils that are subject to instability on storage or during transportation can be treated with additives in order to stabilizer the crude oil in regard to precipitating contaminants such as asphaltenes. Alkylphenol resins with at least a second component selected from the group consisting of a fatty acid amides, mannich resins and mixtures thereof are effective additives for stabilizing crude oils.

### CROSS REFERENCE TO RELATED APPLICATIONS

This application claims priority from U.S. Provisional Patent Application Ser. No. 60/977,426 which was filed on Oct. 4, 2007 and is fully incorporated herein by reference.

### BACKGROUND OF THE INVENTION

1. Field of the Invention

The present invention relates to crude oil additives. The present invention particularly relates to crude oil additives useful for stabilizing crude oils.

2. Background of the Art

Many formation fluids such as petroleum fluids contain a large number of components with a very complex composition. Some of the components present in production fluid, for example wax and asphaltenes, can form or contain solids under ambient conditions, particularly at ambient temperatures and pressures. Asphaltenes are typically dark brown to black-colored amorphous solids with complex structures and relatively high molecular weight. In addition to carbon and hydrogen, asphaltenes also can contain nitrogen, oxygen and sulfur species. Typical asphaltenes are known to have some solubility in the production fluid itself or in certain solvents like carbon disulfide, but are usually insoluble in solvents like light naphthas. Asphaltenes exist as colloidal solids in the oil dispersed by other components in the oil, keeping them suspended and dispersed in the oil.

When the formation fluid from a subsurface formation comes into contact with a pipe, a valve or other production equipment of a wellbore or when there is a change in temperature, pressure, or change of other conditions, asphaltenes may precipitate or separate out of a well stream or the formation fluid while flowing into and through the wellbore to the wellhead. While any asphaltene separation or precipitation is undesirable in and by itself, it is much worse to allow the asphaltene precipitants to accumulate by sticking to the equipment in the wellbore. Any asphaltene precipitants sticking to the wellbore surfaces may narrow pipes; and clog wellbore perforations, various flow valves, and other wellsite and downhole equipment.

For purposes of the present invention, the term “crude oil” means the petroleum fluids produced from an oil well. Typically, the crude oil produced from an oil well is treated to remove excess water and inorganic solids such as salt and then collected and stored for shipment to a refinery. Often, the crude oil from several fields can be accumulated at a central point for shipping through a pipeline or transported by vessel.

Precipitations and accumulations of asphaltenes in a pipeline for transferring crude oil could result in loss of oil flow and/or equipment failure. Crude oil storage facilities could have maintenance or capacity problems if asphaltene precipitations occur during shipping of crude oil. Precipitation of asphaltene during shipping is clearly just as undesirable as during production. Unstable asphaltenes will have negative impact on refinery operations when oil is received by the refinery resulting in lost production and decreased economic output.

### SUMMARY OF THE INVENTION

In one aspect, the invention is an additive useful for stabilizing crude oils comprising at least a first component which is an alkylphenol resin and further comprising a second component selected from the group consisting of a fatty acid amide, a mannich resin and mixtures thereof.

In still another aspect, the invention is a method for stabilizing crude oils comprising admixing a crude oil with an additive useful for stabilizing crude oils comprising at least a first component which is an alkylphenol resin and further comprising a second component selected from the group consisting of a fatty acid amide, a mannich resin and mixtures thereof.

### DESCRIPTION OF THE PREFERRED EMBODIMENTS

In one embodiment, the present invention is an additive useful for stabilizing crude oils comprising at least a first component which is an alkylphenol resin. The alkyl phenol resins useful as the first component of the additives of the invention include those prepared by reacting an alkyl phenol with an aldehyde. The alkyl phenol may be nonyl phenol but other alkyl phenols may be used. Exemplary alkyl phenols useful for preparing the alkyl phenol resin of the invention include those having the general formula:

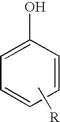

wherein R is an alkyl group having from 4 to 18 carbons.

The alkyl phenol resin may be prepared by reacting the alkyl phenol with an aldehyde. Aldehydes useful for preparing the alkyl phenol resins include formaldehyde, but higher aldehydes may also be used. Higher aldehydes which may be used to prepare the alkyl phenol resins include those aldehydes having from 2 to about 5 carbons.

The alkyl phenol resins may have a molecular weight (M_{w}) of from about two thousand to about twenty five thousand Daltons. In one embodiment, the alkyl phenol resin has a molecular weight of from about four to about twenty thousand Daltons. In still another embodiment, the alkyl phenol resin has a molecular weight of from about five to about ten thousand Daltons. While the structure of the alkyl phenol resins useful with the invention has been described as the reaction product certain starting materials, the alkyl phenol resins may be prepared by any means known to those skilled in art to be useful for preparing such resins.

In another embodiment, the additives of the invention may also include second component selected from the group consisting of fatty acid amides, mannich resins and mixtures thereof. The fatty acid amides useful with the invention include those prepared using a fatty acid having from 8 to about 26 carbons. The amides may be prepared using a hydroxyl alkyl amine such as 2-(2-amino ethylamine)ethanol, diethanolamine, or aminoethyl ethanolamine or other hydroxyl alkyl amine having from about 4 to about 8 carbons. While the structure of the fatty acid amides useful with the invention has been described as the reaction product certain starting materials, the fatty acid amides may be prepared by any means known to those skilled in art to be useful for preparing such resins.

Mannich resins useful with the invention include those which may be prepared using an alkyl phenol, an aldehyde and a polyamine. The alkyl phenols useful in preparing the Mannich resins include those already described above, namely those phenols also having an alkyl group on the aromatic ring having from about 4 to about 8 carbons. For example dodecyl phenol may be used to prepare the Mannich resins useful with the invention.

Similarly the Mannich resins useful with the invention include those made with formaldehyde but may also include those prepared with higher aldehydes. Higher aldehydes which may be used to prepare the Mannich resins include those aldehydes having from 2 to about 5 carbons.

The polyamines useful for preparing the mannich resins include ethylene diamine, but other amines may also be used. Any amine having at least two amino groups and from 2 to 22 carbons may be used to prepare the Mannich resins.

The Mannich resins may have a molecular weight M_{w} of from about two thousand to about twenty five thousand Daltons. In one embodiment, the Mannich resin has a molecular weight of from about four to about twenty thousand Daltons. In still another embodiment, the Mannich resin has a molecular weight of from about five to about ten thousand Daltons. While the structure of the Mannich resins useful with the invention has been described as the reaction product certain starting materials, the Mannich resins may be prepared by any means known to those skilled in art to be useful for preparing such resins.

The invention is, in one embodiment, a method stabilizing crude oils comprising admixing a crude oil with an additive useful for stabilizing crude oils. The additives are admixed with the crude oils using any method known by those of ordinary skill in the art to be useful. For example, in one embodiment, the additives are admixed with the crude oils when the crude oils are being prepared by admixing oils of varying viscosity to achieve a target viscosity. In another embodiment, the additives are admixed when the crude oils being subjected to treatment using the additives are being metered into a truck, ship or other vessel.

The actual means of admixing a crude oil with an additive of the invention may include any apparatus useful for same. Exemplary apparatus include static mixers, blade mixers, stirred vessels, vessels having recycle lines incorporating static or blade mixers, and the like. Any apparatus for mixing known to be useful to those of ordinary skill in the art may be used with the method of the invention. Passive admixing may be accomplished where the additives are introduced into a vessel or transfer line or pipeline and admixing is effected by means of turbulence.

The additives of the present invention may be admixed with crude oil from any source and at any point during production, transportation, and refining of crude oil. Exemplary of locations where the additives of the invention may be added include but are not limited to: 1) downhole, 2) phase separators, 3) collection points for pipelines, pipelines, storage vessels, transfer lines, heat exchangers, thermal cracking units, and the like.

The concentration of the additives needed to stabilize a given crude oil will vary depending upon the properties of the subject crude oil. For example, a crude oil that is comparatively low in destabilizing contaminants such as asphaltenes will require less additive than a crude oil that has a comparatively high amount of asphaltenes. Still, in at least one embodiment, the method of the invention may be practiced by admixing sufficient additive to achieve a concentration of from 5 to about 3000 ppm (by weight) of additive in the crude oil being treated. In other embodiments, the concentration is from about 10 to 2000 ppm. In still other embodiments, the concentration is from about 50 to about 1000 ppm.

The additives of the invention may be used with any crude oil. The crude oils which are most likely to need the additives of the invention are those characterized as heavy crude oils.

### EXAMPLES

The following examples are provided to illustrate the invention. The examples are not intended to limit the scope of the invention and they should not be so interpreted. Amounts are in weight parts or weight percentages unless otherwise indicated.

### Hypothetical Example 1

An additive is prepared using the components shown in the Table. The alkyl phenol resin is an alkyl phenol resin prepared using nonyl phenol and formaldehyde and has a molecular weight (M_{w}) of 2000 to 5000 g/mole done using a GPC and polystyrene standard. The Mannich resin is prepared using dodecyl phenol, formaldehyde and ethylene diamine. It has a molecular weight similar to that of the alkyl phenol resin. The fatty acid amide is prepared using a C18 fatty acid and aminoethyl ethanol amine. The additive is admixed with a crude oil and subjected to a storage study. The symbol + means a small amount of precipitation. The symbol ++ means a medium amount of precipitation. And the symbol +++ means a comparatively large amount of precipitation.

TABLE

| | | Alkylphenol | Mannich | |
|---|---|---|---|---|
| | | Resin | Resin | Fatty Acid Amide |
| Sample # | Precipitation | [%] | [%] | [%] |
| 1-1* | +++ | 0 | 0 | 0 |
| 1-2* | ++ | 100 | 0 | 0 |
| 1-3 | + | 60 | 40 | 0 |
| 1-4 | + | 60 | 0 | 40 |
| 1-5 | + | 60 | 20 | 20 |
| 1-6* | ++ | 0 | 100 | 0 |
| 1-7* | ++ | 0 | 0 | 100 |

*Not an example of the invention

What is claimed is:

1. An additive for stabilizing crude oils comprising a first component which is an alkylphenol resin and a second component selected from the group consisting of a fatty acid amide, a mannich resin and mixtures thereof.

2. The additive of claim 1 wherein the alkyl phenol resin is prepared using an alkyl phenol having a general formula: 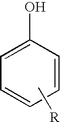
wherein R is an alkyl group having from 4 to 18 carbons.

3. The additive of claim 2 wherein the alkylphenol is reacted with formaldehyde to form the alkylphenol resin.

4. The additive of claim 1 wherein the alkylphenol resin has a molecular weight (M_{w}) of from about 2,000 to about 20,000 Daltons.

5. The additive of claim 1 wherein the second component is a fatty acid amide having from about 8 to about 26 carbons.

6. The additive of claim 5 wherein the fatty acid amide is prepared using a compound selected from the group consisting of 2-(2-amino ethylamine)ethanol, diethanolamine, aminoethyl ethanolamine and mixtures thereof.

7. The additive of claim 1 wherein the second component is a mannich resin prepared from a formulation including an alkyl phenol, an aldehyde and a polyamine.

8. The additive of claim 7 wherein the alkyl phenol has a general formula: 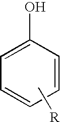
wherein R is an alkyl group having from 4 to 18 carbons.

9. The additive of claim 8 wherein the alkyl phenol is dodecyl phenol.

10. The additive of claim 7 wherein the aldehyde is formaldehyde.

11. The additive of claim 7 wherein the polyamine has from 2 to 22 carbons.

12. The additive of claim 11 wherein the polyamine is ethylene diamine.

13. The additive of claim 1 wherein the second component is a mannich resin having a molecular weight (M_{w}) of from about from about 2,000 to about 25,000 Daltons.

14. The additive of claim 13 wherein the second component is a mannich resin having a molecular weight (M_{w}) of from about from about 4,000 to about 20,000 Daltons.

15. The additive of claim 13 wherein the second component is a mannich resin having a molecular weight (M_{w}) of from about from about 5,000 to about 10,000 Daltons.

16. A method for stabilizing crude oils comprising admixing a crude oil with an additive for stabilizing crude oils comprising a first component which is an alkylphenol resin and a second component selected from the group consisting of a fatty acid amide, a mannich resin and mixtures thereof.

17. The method of claim 16 wherein the additive is admixed with the fuel oil at a concentration of from about 5 to about 3,000 ppm.

18. The method of claim 17 wherein the additive is admixed with the fuel oil at a concentration of from about 50 to about 1,000 ppm.

19. The method of claim 16 wherein the additive is introduced into a vessel, transfer line, or pipeline containing crude oil.

20. A composition comprising an admixture of the additive of claim 1 and crude oil.
